(19) United States
(12) Patent Application Publication
(10) Pub. No.: US 2012/0079263 A1
(43) Pub. Date: Mar. 29, 2012

(54) Method and Device for Initiating System on Chip

(75) Inventor: Yunfeng Weng, Shenzhen (CN)

(73) Assignee: ZTE CORPORATION, Shenzhen City, Guangdong Province (CN)

(21) Appl. No.: 13/257,916

(22) PCT Filed: Jun. 8, 2010
(86) PCT No.: PCT/CN10/73671

§ 371 Date: Oct. 10, 2011

(30) Foreign Application Priority Data
Jun. 19, 2009 (CN) 200910147766.1

(51) Int. Cl. G06F 9/445

(52) U.S. Cl. 713/2

(57) ABSTRACT

A method and apparatus for starting a system on chip, this method includes: enumerating all interfaces which are able to start after the system on chip is powered on and an initial boot program is started; and reading measurement data of each starting interface in sequence, and when it is detected that a certain starting interface has connected with a starting device and this starting device is the only, load a subsequent boot program from this starting interface to complete system starting. The method solves the problem that the system on chip is only able to be started in the fixed configuration from the fixed interface or device, and the system on chip is unable to be started once the external starting environment changes existing in the prior art.

### TECHNICAL FIELD

The present invention relates to the embedded device field, and particularly, relates to a method and apparatus for starting a System on Chip (SoC).

### BACKGROUND OF THE RELATED ART

The SoC is a highly integrated and firmware system integration chip. The SoC is centered at the application, and is a dedicated computer system which has a strict requirement for integration indexes such as the functions, performance, reliability, cost, volume, power consumption and so on. It includes the whole hardware and software systems, and is a microminiature computer system which is able to complete specified functions.

The SoC is mainly composed of the embedded processor (the Central Processing Unit (CPU) or the Digital Signal Processing (DSP)), memory, related support hardware, embedded operation system and application software and so on, and from the narrow point of view, it is the chip integration of the information system core, and integrates key components of the system into one chip; and from the broad point of view, the SoC is a micorminiature system.

The SoC is composed of two parts of the hardware and software, its composition can be the system level chip control logic module, microprocessor/micro controller (CPU) kernel module, Digital Signal Processing (DSP) module, embedded memory module, the interface module communicating with the external, the analog front end module including the Analog to Digital Converter (ADC)/Digital to Analog Converter (DAC), and power supply and power consumption management module, and one wireless SoC further comprises a radio front end module, user defined logic and micro-electronic mechanism module, and the more important is one SoC chip in which the basic software module or loadable user software and so on are embedded.

The software part of the SoC mainly comprises the Boot loader, system kernel and application software, and the system kernel and the application software are considered as an inseparable whole in many SoC software systems. The Boot loader is the first segment code executed after the hardware system is powered on or reset, and its main tasks comprise: initializing the necessary hardware environment, and loading and executing the system kernel.

When the SoC is powered on or reset, the SoC usually will start to load and execute the code according to a fixed hardware logic or directly start to execute the code from a specified internal address, and this address stores the Boot loader program of the system, and since this code can not be changed after the hardware design completes the tape-out, this code is also called as the “firmware”.

The existing SoC is generally to store the Boot loader code into the firmware, and when the SoC is powered on, the system program is loaded and executed from the external through a certain specified interface, and the SoC is started in this way, and the specific structure diagram of the system of the SoC externally connecting the universal starting device is shown in FIG. 1. Since the SoC chip has the characteristic of firmware being unable to be changed after tape-out, this firmware plays a crucial role in the processes of the SoC initialization and the system loading, and once the external starting environment (the interface or device) of the SoC changes, it will cause directly that the SoC is unable to work. Therefore, this field requires a more flexible Boot loader method.

### SUMMARY OF THE INVENTION

The present invention provides a method and apparatus for starting a system on chip, so as to solve the problem that the system on chip is only able to be started in the fixed configuration from the fixed interface or device, and the system on chip is unable to be started once the external starting environment changes existing in the prior art.

A method for starting a System on Chip comprises:
enumerating all interfaces which are able to start after the system on chip is powered on and an initial boot program is started;
reading measurement data of each starting interface in sequence, and when it is detected that a certain starting interface has connected with a starting device and this starting device is the only, loading a subsequent boot program from this starting interface to complete system starting.

Wherein said measurement data include an indication parameter for indicating whether a current interface has connected with a starting device.

Said measurement data further includes a priority parameter for indicating a priority of the starting interface.

After the step of reading measurement data of each starting interface in sequence, said method further comprises: when it is detected that a certain starting interface has connected with a starting device and this starting device is not the only, detecting and obtaining all the starting interfaces which have connected with starting devices and corresponding priority parameters in sequence, taking an interface with a highest priority as the starting interface, loading the subsequent boot program from this starting interface to complete system starting.

After the step of reading measurement data of each starting interface in sequence, said method further comprises:
when that all enumerated starting interfaces have not connected with the starting device is detected, outputting error information.

Said measurement data are used for judging whether said starting device is valid.

The present invention further provides an apparatus for starting a system on chip, and this apparatus comprises:
an interface enumerating module, which is configured to: enumerate all interfaces which are able to start after the system on chip is powered on and an initial boot program is started; and
a starting interface obtaining module, which is configured to: read measurement data of each starting interface in sequence, and when that a certain starting interface has connected with a starting device and this starting device is the only is detected, load a subsequent boot program from this starting interface to complete system starting.

Wherein said measurement data include an indication parameter for indicating whether a current interface has connected with a starting device.

Said measurement data further include a priority parameter for indicating a priority of the starting interface.

Said starting interface obtaining module is further configured to: detect and obtain all the starting interfaces which have connected with starting devices and corresponding priority parameters in sequence when that a certain starting interface has connected with a starting device and this starting device is not the only is detected, and take an interface with a highest priority as the starting interface, and load the subsequent boot program from this starting interface to complete system starting.

Said starting interface obtaining module is further configured to: output error information when that all enumerated starting interfaces have not connected with the starting device is detected.

Comparing with the prior art, the present invention has the following advantages:
the method used in the present invention makes progress on the universal design of the hardware and software, which effectively reduces the hardware cost and the system on chip (SoC) cost of the system, and when the external platform changes and the SoC requires starting by different interfaces and modes, the SoC chip is able to automatically adapt to this demand in a premise of not carrying out tape-out over again, not modifying the firmware version, and not making other modifications, which achieves the higher adaptability and broader adaptation scope when the SoC is integrated, improves the applicability and robustness when the SoC chip is started and integrated, reduces the hardware cost and the SoC cost of the system, and effectively extends the valid lifecycle of the SoC.

### BRIEF DESCRIPTION OF DRAWINGS

In order to more clearly describe the technical scheme of examples of the present invention or the related art, below it will briefly introduce the figures which should be used in the description of examples or the related art, and obviously, the figures in the following description are only a plurality of examples of the present invention, and other figures can also be obtained according to these figures without the creative work for a person skilled in the art.

FIG. 1 is a structure diagram of the system of the SoC externally connecting the universal starting device in the related art;

FIG. 2 is a flow chart of the method for starting a system on chip provided in the present invention;

FIG. 3 is a structure diagram of the system of the SoC externally connecting an optional starting device provided in the example of the present invention;

FIG. 4 is a flow chart of SoC enumerating the starting devices provided in the example of the present invention;

FIG. 5 is a flow chart of SoC enumerating the starting devices provided in another example of the present invention;

FIG. 6 is a structure diagram of the system of the SoC externally connecting an optional starting device provided in another example of the present invention;

FIG. 7 is a subject flow chart of starting the SoC system provided in the example of the present invention;

FIG. 8 is a structure diagram of the apparatus for starting a system on chip provided in the present invention.

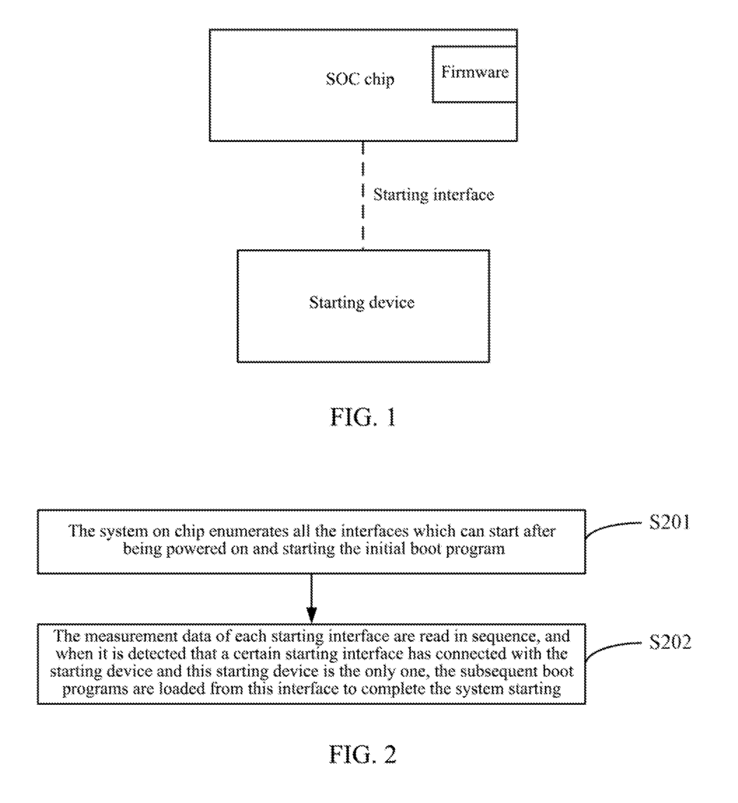

### PREFERRED EMBODIMENTS OF THE PRESENT INVENTION

Below it will clearly and completely describe the technical scheme in examples of the present invention with reference to figures in examples of the present invention, and obviously, the described examples are only a part of examples instead of all the examples. Based on the examples in the present invention, all of the other examples obtained by the ordinary person skilled in the art without the creative work shall all fall into the protection scope of the present invention.

Regarding the problem that the SoC is only able to be started in the fixed configuration from the fixed interface or device, and the SoC is unable to be started once the external starting environment changes in the prior art, the present invention provides a method and apparatus for starting a system on chip, so that the SoC is able to automatically enumerate a plurality of interfaces of the SoC to attempt to start the interface or device, and SoC will enumerate valid starting interfaces or devices by the enumerating action after the external starting environment (the interface or device) of the SoC changes, and once the enumeration succeeds, the SoC is started from the valid starting interfaces, and the method of multi-segment boot is used, which improves the adaptability and flexibility of the SoC starting, and a way of configuring different hardware parameters during starting regarding to different SoC integration platforms is used to optimize its starting performance. The present invention either does not need to make any modification on the external starting interface or the device itself, or does not need to modify any SoC internal hardware circuit to be implemented.

Specifically, the present invention provides a method for starting a system on chip, and as shown in FIG. 2, comprises following steps of:
step S201, the system on chip enumerates all the interfaces which can start after being powered on and starting the initial boot program.

Step S202, the measurement data of each starting interface are read in sequence, and when it is detected that a certain starting interface has connected with the starting device and this starting device is the only, the subsequent boot programs are loaded from this interface to complete the system starting.

Wherein the measurement data include the indication parameter used for indicating whether the current interface has connected with the starting device.

The measurement data also can include the priority parameter used for indicating the priority of the starting interface.

Specifically, this step also can carry out following operations:
when it is detected that a certain starting interface has connected with a starting device and this starting device is not the only, detecting and obtaining all the starting interfaces connecting with the starting devices and their priority parameters in sequence, and taking the interface with the highest priority therein as a starting interface, and loading subsequent boot programs from this interface to complete the system starting.

When it is detected that all the enumerated starting interfaces have not connected with the starting device, error information is outputted.

The method provided in the present invention efficiently reduces the hardware cost and SoC cost of the system, and when the external platform changes and the SoC requires starting in different interfaces and modes, the SoC chip is able to automatically adapt to this demand in a premise of not carrying out tape-out over again, not modifying the firmware version, and not making other modifications, which achieves the higher adaptability and broader adaptable scope when the SoC is integrated, improves the applicability and robustness when the SoC chip is started and integrated, reduces the hardware cost and the SoC cost of the system, and effectively extends the valid lifecycle of the SoC.

Below it will illustrate a specific implementation process of the method for starting the system on chip provided in the present invention in detail with reference to a preferable example.

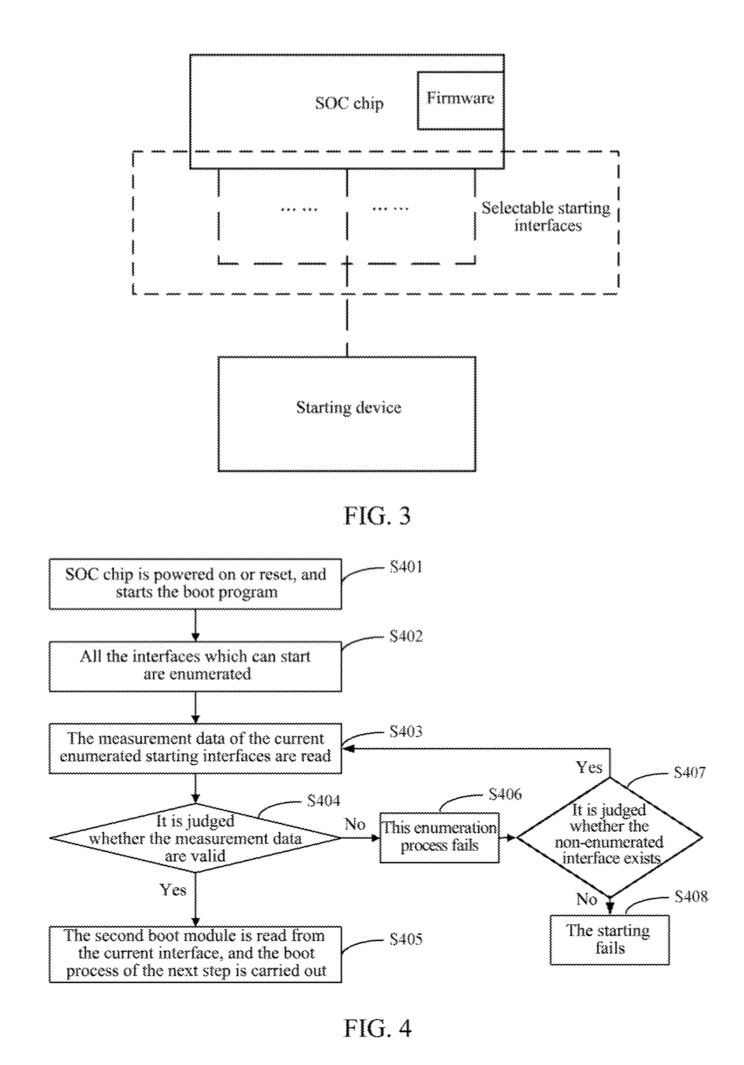

FIG. 3 is a system structure diagram of the SoC externally connecting an optional starting device according to the present invention, and as shown in FIG. 3, this system comprises: a SoC chip, a starting device, and a plurality of optional starting interfaces, and this system stores a plurality of boot programs, which are respectively stored in the first boot module inside the SoC chip firmware and the second boot module and the third boot module in the starting device, wherein the first boot module is used for the initial initialization of the SoC chip, and enumerating valid interfaces which can start.

Preferably, the embodiment of the first boot module enumerating the starting interfaces, as shown in FIG. 4, specifically comprises following steps:
step S401, the system starts the boot program inside the first boot module after being powered up and started, and this boot program carries out the necessary initialization on the hardware.

Step S402, all the interfaces which can start are enumerated, and necessary initialization operations are carried out on the current enumerated interface, and its initialization operations also can be carried out together in the step S401.

Step S403, the measurement data of the current enumerated interface are read.

Wherein measurement data include the indication parameter for indicating whether the current interface has connected with the starting device, and whether the current interface has connected with the starting device can be judged by judging whether this indication parameter is valid. That the indication parameter is valid indicates the real data read from the starting device, and indicates the current interface has connected with the starting device; that the indication parameter is invalid indicates the default high level or low level on the data input line of the current starting interface, and indicates the current interface has not connected with the starting device, but is in a floating state.

In the practical operations, judge whether the indication parameter in the measurement data is valid by judging whether the indication bits are all 0 or all 1, or comply with a specific value, and if not all 0 or not all 1, or do not comply with a specific value, then it is judged that the current interface has connected with the memory device and it can be started from this interface, or else, it denotes that the current interface has not connected with the starting device or non starting device, but is in the floating state.

Step S404, the read measurement data are analyzed, and it is judged whether the indication parameter in the measurement data is valid, and if yes, it is judged that the current interface has connected with the starting device and it can be started from this interface, and step S405 is carried out; or else step S406 is carried out.

Step S405, the second boot module is read from the current enumerated interface, and the boot process of the next step is carried out.

Step S406, it is judged that the current enumerated interface has not connected with the starting device, and this enumeration process fails.

Step S407, it is judged whether the non-enumerated interface exists, and if exists, the next starting interface is enumerated, and return to the step S403; if does not exist, it denotes that all the interfaces are not the starting interface, namely, all the interfaces have not connected with the starting device, step S408 is carried out.

Step S408, all the interfaces are enumerated, and there is not an interface which can start existing, and the starting fails, and error information is outputted.

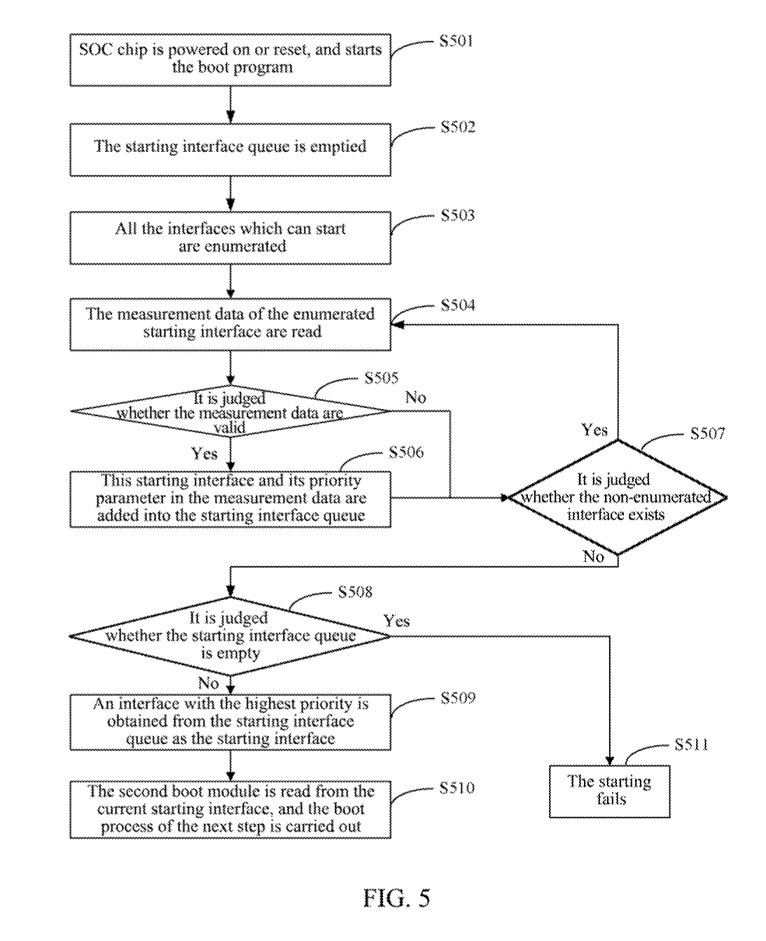

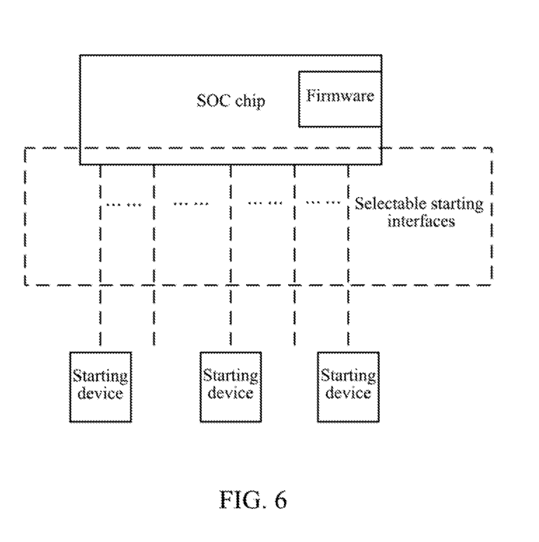

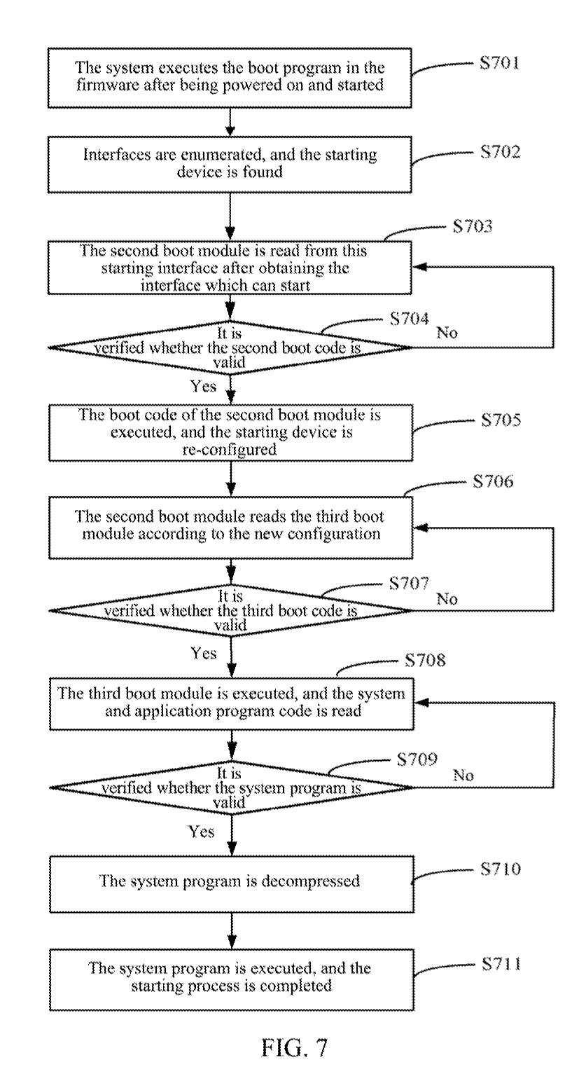

As shown in FIG. 5, it is another embodiment of the first boot module enumerating the starting interfaces, and the structure diagram of the system of the system on chip externally connecting an optional starting device of this embodiment is shown in FIG. 6, wherein a plurality of starting interfaces have all connected with the starting device, and the specific process of enumerating the starting interfaces in this embodiment comprises following steps:

Step S501, the system starts the boot program inside the first boot module after being powered up and reset, and necessary initialization is carried out on the hardware through this boot program.

Step S502, the starting interface queue is emptied. This starting interface queue is used for storing all the successfully enumerated interfaces which can start and the read measurement data.

Step S503, all the interfaces which can start are enumerated, and necessary initialization operations are carried out on the current interface, and its initialization operations also can be carried out together in the step S501.

Step S504, the measurement data of the current enumerated starting interface are read. Wherein, measurement data include the indication parameter used for judging whether the starting interface has connected with the starting device and the priority parameter used for indicating the priority of this starting interface.

Step S505, the read measurement data are analyzed, and it is judged whether the indication parameter of the starting interface in the measurement data complies with a pre-set characteristic value, and if complies, it denotes that the measurement data are valid, and it is judged that the current interface has connected with the starting device and it can be started from this interface, and step S506 is carried out; or else it denotes that the measurement data are invalid, and step S507 is carried out.

Step S506, this starting interface and its priority parameter in the measurement data are added into the starting interface queue, and step S507 is carried out.

Step S507, it is judged whether all the starting interfaces are enumerated, and if there is an interface which is not enumerated, the next starting interface is continued to be enumerated, and go to the step S504, and if all the interfaces are completed to be enumerated, the step S508 is carried out.

Step S508, it is judged whether the starting interface queue is empty, and if it is empty, it denotes that an interface which can start is not found, and go to step S511, or else go to step S509.

Step S509, an interface with the highest priority is obtained from the starting interface queue as the starting interface.

Step S510, the second boot module is read from the current starting interface, and the boot process of the next step is carried out.

Step S511, all the starting interfaces are enumerated, and there is not an interface which can start existing, and the starting fails, and error information is outputted.

Below it will illustrate the whole flow of starting the system on chip in detail according to the example of the present invention, and as shown in FIG. 7, it specifically comprises following steps:

Step S701, the system executes the boot program inside the first boot module in the firmware at first after being powered on and started, and necessary initialization is carried out on the hardware through this boot program at first.

Step S702, the first boot module starts to enumerate the starting interfaces, and searches the starting device. This enumeration process can be optionally executed according to the specific number of the starting devices.

Step S703, the second boot module is read from the starting interface after obtaining the interface which can start.

Step S704, the second boot module is verified after completing to read the second boot module, and if an error occurs in verification, the error information is outputted, and go to the step S703, or stop the boot directly; if the verification succeeds, go to the step S705.

Step S705, the second boot module is executed, and this module may optimize the SoC hardware so as to improve its starting performance, and this module is able to modify its starting interface and related configuration over again so as to better adapt to the demands of the specific platform.

It should be described that the second boot module is able to be stored in the external re-writable or non re-writable memory medium of the SoC, and the manufacturer is able to modify the second boot template code thereof according to the system integration platform of the customer after the customer builds the chip integration platform, and then provides to the customer so as to adapt to the integration platform of the customer and improve its starting performance; however, the modification is not absolutely necessary, and is determined according to whether the hardware of the integration environment of the customer is compatible with the design of the manufacturer and whether the customer satisfies this starting performance.

Specifically, in the existing common implementation schemes, in order to make the SoC products compatible with more integration platforms, particularly in the scheme of using the non-fixed memory device but the starting data being provided by the integration platform, the transmission performance index of the starting interface of the SoC chip (including but not limited to the bit width of the interface, interface frequency and so on) is generally defined lower so as to meet the demands of normally communicating with more types of integration platforms. Thus it will cause that the SoC will spend more transmission time during the starting; and in order to make all the data of different versions of SoC systems and application program codes to be read, the existing scheme usually compromises and adopts a way of reading data of which the length is far more than the length of the SoC system and application program code to achieve the goal, thus the SoC chip wastes more transmission time during the starting. The second boot module of the present invention is stored in the non-firmware, which is modified according to different customer integration platforms, and the configuration is carried out on the SoC chip over again according to the characteristic of this customer integration platform after being loaded and run by the first boot module, and this configuration will improve the transmission performance of starting interface of the SoC chip at the utmost in the premise of ensuring the correctness of the data transmission; and only the data of the length of the SoC system and application program itself are read; thus it will greatly reduce the data transmission time on the starting interface, improve the starting speed of the SoC and reduce the corresponding operation time of the customer integration platform. Furthermore, it also can integrate the decompression module into the second boot module (which also can be the third boot module) to decompress the received data, which will further reduce the data transmission time on the starting interface.

Step S706, the second boot module reads the third boot module according to the new configuration.

Step S707, the third boot module is verified after reading the third boot module, and if an error occurs in the verification, the error information is outputted, and go to the step S706, or stop the boot directly; if the verification succeeds, go to the step S708.

Step S708, the third boot module is executed, and the system and application program code is read from the third boot module, wherein the third boot module maybe include complex functions such as the stub procedures used by the debugging, modules used by the emulator, network support modules, complex output modules, loading modules of the system and application program, and decompression module and so on.

Step S709, the system and application program code is verified by the third boot module after completing to read the system and application program, and if an error occurs in the verification, the error information is outputted, and go to the step S708, or stop the boot directly. If the verification succeeds, go to the step S710.

Step S710, this step is an optional step, the verified system and application program code is decompressed regarding to the case of the system and application program code being compressed, and is moved to the specified location.

Step S711, the third boot module surrenders the control, starts to execute the system and application program, and completes the whole starting process.

The method for starting the SoC provided by the present invention makes progress on the universal design of the hardware and software, which effectively reduces the hardware cost and the SoC cost of the system, and when the external platform changes and the SoC requires starting by different interfaces and modes, the SoC chip is able to automatically adapt to this demand in a premise of not carrying out tape-out over again, not modifying the firmware version, and not making other modifications, which achieves the higher adaptability and broader adaptation scope when the SoC is integrated, improves the applicability and robustness when the SoC chip is started and integrated, reduces the hardware cost and the SoC cost of the system, and effectively extends the valid lifecycle of the SoC.

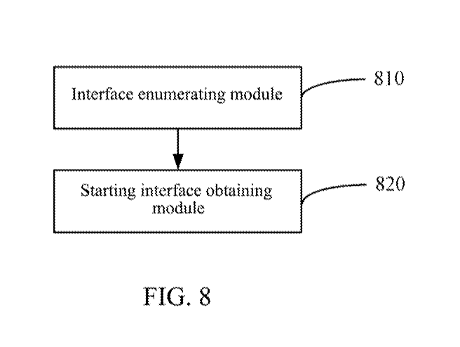

The present invention further provides an apparatus for starting a system on chip, and as shown in FIG. 8, comprises:
an interface enumerating module 801, which is used for enumerating all the interfaces which can start after the system being powered on and starting the initial boot program;
a starting interface obtaining module 820, which is used for reading measurement data of each starting interface in sequence, and when that a certain starting interface has connected with a starting device and this starting device is the only is detected, loading subsequent boot programs from this interface to complete the system starting.

Wherein the measurement data include the indication parameter used for indicating whether the current interface has connected with the starting device.

This measurement data also can include the priority parameter used for indicating the priority of the starting interface.

Furthermore, the starting interface obtaining module 820 is further used for detecting and obtaining all the starting interfaces which have connected with the starting device and their priority parameters in sequence when that a certain starting interface has connected with the starting device and this starting device is not the only is detected, taking the interface with the highest priority therein as the starting interface, and loading subsequent boot programs from this interface to complete the system starting.

The starting interface obtaining module 820 is further used for outputting error information when that all the enumerated starting interfaces have not connected with the starting device is detected.

The apparatus provided in the present invention effectively reduces the hardware cost and the SoC cost of the system, and when the external platform changes and the SoC requires starting by different interfaces and modes, the SoC chip is able to automatically adapt to this demand in a premise of not carrying out tape-out over again, not modifying the firmware version, and not making other modifications, which achieves the higher adaptability and broader adaptation scope when the SoC is integrated, improves the applicability and robustness when the SoC chip is started and integrated, reduces the hardware cost and the SoC cost of the system, and effectively extends the valid lifecycle of the SoC.

Obviously, various modifications and transformations can be made to the present invention by those having ordinary skills in the art without departing from the spirit or scope of the present invention. Thus, if these modifications and transformations of the present invention fall into the scope of the appended claims of the present invention and their equivalent technique, then the present invention also intends to include these modifications and transformations.

### INDUSTRIAL APPLICABILITY

The method used in the present invention makes progress on the universal design of the hardware and software, which effectively reduces the hardware cost and the SoC cost of the system, and when the external platform changes and the SoC requires starting by different interfaces and modes, the SoC chip is able to automatically adapt to this demand in a premise of not carrying out tape-out over again, not modifying the firmware version, and not making other modifications, which achieves the higher adaptability and broader adaptation scope when the SoC is integrated, improves the applicability and robustness when the SoC chip is started and integrated, reduces the hardware cost and the SoC cost of the system, and effectively extends the valid lifecycle of the SoC.

What is claimed is:

1. A method for starting a system on chip, and this method comprising:
enumerating all interfaces which are able to start after the system on chip being powered on and starting an initial boot program;
reading measurement data of each starting interface in sequence, and when that a certain starting interface has connected with a starting device and this starting device is the only is detected, loading a subsequent boot program from this starting interface to complete system starting.

2. The method as claimed in claim 1, wherein said measurement data include an indication parameter for indicating whether a current interface has connected with the starting device.

3. The method as claimed in claim 2, wherein said measurement data further include a priority parameter for indicating a priority of the starting interface.

4. The method as claimed in claim 3, after the step of reading measurement data of each starting interface in sequence, said method further comprising: when that a certain starting interface has connected with a starting device and this starting device is not the only is detected, detecting and obtaining all the starting interfaces which have connected with starting devices and corresponding priority parameters in sequence, taking an interface with a highest priority as the starting interface, loading the subsequent boot program from this starting interface to complete system starting.

5. The method as claimed in claim 1, after the step of reading measurement data of each starting interface in sequence, said method further comprising:
when that all enumerated starting interfaces have not connected with the starting device is detected, outputting error information.

6. The method as claimed in claim 1, wherein said measurement data are used for judging whether said starting device is valid.

7. An apparatus for starting a system on chip, and this apparatus comprising:
an interface enumerating module, which is configured to: enumerate all interfaces which are able to start after the system on chip being powered on and starting an initial boot program; and
a starting interface obtaining module, which is configured to: read measurement data of each starting interface in sequence, and when that a certain starting interface has connected with a starting device and this starting device is the only is detected, load a subsequent boot program from this starting interface to complete system starting.

8. The apparatus as claimed in claim 7, wherein said measurement data include an indication parameter for indicating whether a current interface has connected with the starting device.

9. The apparatus as claimed in claim 8, wherein said measurement data further include a priority parameter for indicating a priority of the starting interface.

10. The apparatus as claimed in claim 9, wherein
said starting interface obtaining module is further configured to: detect and obtain all the starting interfaces which have connected with starting devices and corresponding priority parameters in sequence when that a certain starting interface has connected with a starting device and this starting device is not the only is detected, take an interface with a highest priority as the starting interface, and load the subsequent boot program from this starting interface to complete system starting.

11. The apparatus as claimed in claim 7, wherein
said starting interface obtaining module is further configured to: output error information when that all enumerated starting interfaces have not connected with the starting device is detected.
